(19) United States
(12) Patent Application Publication
(10) Pub. No.: US 2003/0210132 A1
(43) Pub. Date: Nov. 13, 2003

(54) System and method for in-vehicle multimedia unit remote control and remote keyless entry

(75) Inventors: Qingfeng Tang, Novi, MI (US); Riad Ghabra, Dearborn Heights, MI (US); Ronald O. King, Brownstown, MI (US); John S. Nantz, Brighton, MI (US)

Correspondence Address: BROOKS & KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI

(21) Appl. No.: 10/324,640

(22) Filed: Dec. 19, 2002

Related U.S. Application Data
(60) Provisional application No. 60/378,519, filed on May 7, 2002.

(51) Int. Cl. H04Q 1/00; G05B 19/00

(52) U.S. Cl. 340/5.64; 340/5.72

(57) ABSTRACT

A system and method for controlling an in-vehicle entertainment system in a vehicle having a remote keyless entry system. A receiver to be mounted on-board the vehicle is provided in communication with a vehicle access device associated with the remote keyless entry system and receives a radio frequency vehicle access signal for use in controlling a vehicle access function. The receiver is further provided in communication with the in-vehicle entertainment system and receives a radio frequency command signal for use in controlling the in-vehicle entertainment system.

### CROSS REFERENCE TO RELATED APPLICATION

This application claims the benefit of U.S. provisional application Serial No. 60/378,519, filed May 7, 2002.

### BACKGROUND OF THE INVENTION

1. Field of the Invention

The present invention relates to a system and method for remote control of an in-vehicle multimedia unit and a keyless entry system utilizing a shared receiver.

2. Background

It is known in the automotive industry to provide for remote vehicle access, such as through the use of remote keyless entry (RKE) systems. Such RKE systems typically use a hand-held remote transmitter, which is commonly referred to as a “fob” or “card.” Currently available RKE fobs may be separate units, or may be part of an ignition key head. Such RKE fobs generally transmit radio frequency (RF) vehicle access signals to a vehicle in order to lock or unlock vehicle doors, open or close a vehicle sliding door, unlock a vehicle trunk, activate internal and/or external vehicle lights, activate a “panic” alarm, and/or perform a variety of other functions.

RKE systems may be characterized as active or passive systems. In active RKE systems, a switch or pushbutton on the remote transmitter must be activated by an operator in order to have a desired remote access function performed, such as locking or unlocking the vehicle doors. In passive RKE systems, however, no such switch or pushbutton activation by an operator is required in order to perform a desired remote access function. Instead, in a passive RKE system, the remote transmitter is designed to automatically unlock the vehicle as an operator carrying the transmitter approaches the vehicle. Similarly, the system is further designed to automatically lock the vehicle as the operator, carrying the remote transmitter, moves away from the vehicle.

Whether active or passive in nature, RKE systems include a receiver and/or control unit installed in the vehicle. The receiver and/or control unit is provided in communication with door locking mechanisms to lock and unlock the vehicle doors in response to receipt by the receiver of RF command signals transmitted from the remote transmitter within some pre-defined range. Similarly, the receiver and/or control unit may be provided in communication with other vehicle devices to control operation thereof in response to other RF vehicle access signals transmitted from the remote transmitter and received by the receiver.

Automotive vehicles are also increasingly being equipped with in-vehicle multimedia entertainment systems. Such entertainment systems typically include a monitor, a VCR and/or a DVD player, as well as an associated sound system. The monitor may be incorporated into the back of a vehicle seat or another vehicle structure, or may be a flat screen attached to a vehicle headliner and foldable between open and closed positions. In such a fashion, vehicle occupants, particularly those in rear seating areas, may watch and/or listen to a variety of recorded programs. Such entertainment systems may also include headphones, thereby allowing vehicle occupants using the systems to listen to the audio portion of a program without disturbing other vehicle occupants.

Such in-vehicle entertainment systems also typically include a remote control unit for use in controlling various functions of the associated VCR and/or DVD player and sound system. Such remote control units typically transmit RF control signals for use in controlling such equipment, in any fashion known in the art. As a result, such in-vehicle entertainment systems must also include a receiver for receiving such control signals.

Such prior art RKE and multimedia entertainment systems, however, are independent, distinct systems that do not share components. Thus, current in-vehicle multimedia entertainment systems have a dedicated receiver for receiving RF signals for use in controlling various functions of the entertainment system. The need for such a dedicated receiver raises the cost of such an entertainment system. Using the receiver associated with a RKE system for receiving not only RF vehicle access signals from an RKE fob, but also for receiving RF control or command signals from a remote control unit for use in controlling an in-vehicle entertainment system would provide a significant cost advantage over the use of a dedicated receiver.

Thus, in a vehicle having a remote keyless entry system and an in-vehicle entertainment system, there exists a need for a system and method for controlling the in-vehicle entertainment system that would utilize a shared receiver. Such a system and method would preferably include a single receiver for receiving both RF vehicle access signals associated with the remote keyless entry system, and RF command signals associated with the in-vehicle entertainment system. In such a system and method, the shared receiver would preferably be provided in communication with a vehicle access device and the in-vehicle entertainment system using a vehicle bus, thereby allowing the vehicle access device and entertainment system to perform the intended function associated with the vehicle access and entertainment command signals.

### DISCLOSURE OF THE INVENTION

Accordingly, the present invention provides, in a vehicle having a remote keyless entry system and an in-vehicle entertainment system, a system and method for controlling the in-vehicle entertainment system utilizing a shared receiver.

According to the present invention, in a vehicle having a remote keyless entry system and an in-vehicle entertainment system, a system is provided for controlling the in-vehicle entertainment system. The system comprises a remote transmitter for transmitting a radio frequency vehicle access signal for use in controlling a vehicle access function. The system further comprises a receiver to be mounted on-board the vehicle for receiving the vehicle access signal, the receiver to be provided in communication with a vehicle access device for performing the vehicle access function, the receiver further to be provided in communication with the in-vehicle entertainment system and for receiving a radio frequency command signal for use in controlling the in-vehicle entertainment system the present invention provides a system and method for integrated tire pressure monitoring and vehicle passive entry.

According to another embodiment of the present invention, in a vehicle having a remote keyless entry system and an in-vehicle entertainment system, a system for controlling the in-vehicle entertainment system is provided. In this embodiment, the system comprises a remote transmitter for transmitting a radio frequency command signal for use in controlling the in-vehicle entertainment system. The system further comprises a receiver to be mounted on-board the vehicle, the receiver to be provided in communication with the in-vehicle entertainment system and for receiving the command signal, the receiver further to be provided in communication with a vehicle access device and for receiving a radio frequency vehicle access signal for use in controlling the vehicle access device.

Still further according to the present invention, in a vehicle having a remote keyless entry system and an in-vehicle entertainment system, a method is provided for controlling the in-vehicle entertainment system. The method comprises transmitting a radio frequency vehicle access signal from a remote transmitter associated with the remote keyless entry system, and transmitting a radio frequency entertainment system command signal from a remote transmitter associated with the in-vehicle entertainment system. The method further comprises receiving at a vehicle mounted receiver the radio frequency vehicle access signal, and receiving at the vehicle mounted receiver the radio frequency command signal, wherein the vehicle mounted receiver is provided in communication with the in-vehicle entertainment system and with a vehicle access device associated with the remote keyless entry system.

The following detailed description and accompanying drawings set forth preferred embodiments of the present invention.

### BRIEF DESCRIPTION OF THE DRAWINGS

FIG. 1 is a simplified, representative block diagram of an embodiment of the system of the present invention; and

FIG. 2 is a simplified, representative flowchart of an embodiment of the method of the present invention.

### DETAILED DESCRIPTION OF PREFERRED EMBODIMENT(S)

Referring now to the Figures, preferred embodiments of the present invention will now be described in detail. As previously noted, it is known in the automotive industry to provide for remote vehicle access, such as through the use of RKE systems using a hand-held remote transmitter commonly referred to as a “fob.” Currently available RKE fobs may be separate units or may be part of an ignition key head, and generally transmit radio frequency (RF) vehicle access signals to a vehicle in order to lock or unlock vehicle doors, open or close a vehicle sliding door, unlock a vehicle trunk, activate internal and/or external vehicle lights, activate a “panic” alarm, and/or perform a variety of other functions.

RKE systems may be characterized as active or passive systems. In active RKE systems, a switch or pushbutton on the remote transmitter must be activated by an operator in order to have a desired remote access function performed, such as locking or unlocking the vehicle doors. In passive RKE systems, however, no such switch or pushbutton activation by an operator is required in order to perform a desired remote access function. Instead, the remote transmitter is designed to automatically unlock the vehicle as an operator carrying the transmitter approaches the vehicle. Similarly, the system is further designed to automatically lock the vehicle as the operator, carrying the remote transmitter, moves away from the vehicle.

As also noted above, whether active or passive in nature, RKE systems include a receiver and/or control unit installed in the vehicle. The receiver and/or control unit is provided in communication with door locking mechanisms to lock and unlock the vehicle doors in response to receipt by the receiver of RF command signals transmitted from the remote transmitter within some pre-defined range. Similarly, the receiver and/or control unit may be provided in communication with other vehicle devices to control operation thereof in response to other RF vehicle access signals transmitted from the remote transmitter and received by the receiver.

As still further noted previously, automotive vehicles may also be equipped with in-vehicle multimedia entertainment systems. Such entertainment systems typically include a monitor, a VCR and/or a DVD player, as well as an associated sound system. The monitor may be incorporated into the back of a vehicle seat or another vehicle structure, or may be a flat screen attached to a vehicle headliner and foldable between open and closed positions. In such a fashion, vehicle occupants, particularly those in rear seating areas, may watch and/or listen to a variety of recorded programs. Such entertainment systems may also include headphones, thereby allowing vehicle occupants using the systems to listen to the audio portion of a program without disturbing other vehicle occupants.

Such in-vehicle entertainment systems also typically include a remote control unit for use in controlling various functions of the associated VCR and/or DVD player and sound system. Such remote control units typically transmit RF control signals for use in controlling such equipment, in any fashion known in the art. As a result, such in-vehicle entertainment systems must also include a receiver for receiving such control signals.

Such prior art RKE and multimedia entertainment systems, however, are independent, distinct systems that do not share components. Thus, current in-vehicle multimedia entertainment systems have a dedicated receiver for receiving RF signals for use in controlling various functions of the entertainment system. The need for such a dedicated receiver raises the cost of such an entertainment system. Using the receiver associated with a RKE system for receiving not only RF vehicle access signals from an RKE fob, but also for receiving RF control or command signals from a remote control unit for use in controlling an in-vehicle entertainment system would provide a significant cost advantage over the use of a dedicated receiver.

Thus, as also noted above, there exists a need in vehicles having remote keyless entry and in-vehicle entertainment systems for a system and method for controlling the in-vehicle entertainment system that would utilize a shared receiver. Such a system and method would preferably include a single receiver for receiving both RF vehicle access signals associated with the remote keyless entry system, and RF command signals associated with the in-vehicle entertainment system. In such a system and method, the shared receiver would preferably be provided in communication with a vehicle access device and the in-vehicle entertainment system using a vehicle bus, thereby allowing the vehicle access device and entertainment system to perform the intended function associated with the vehicle access and entertainment command signals.

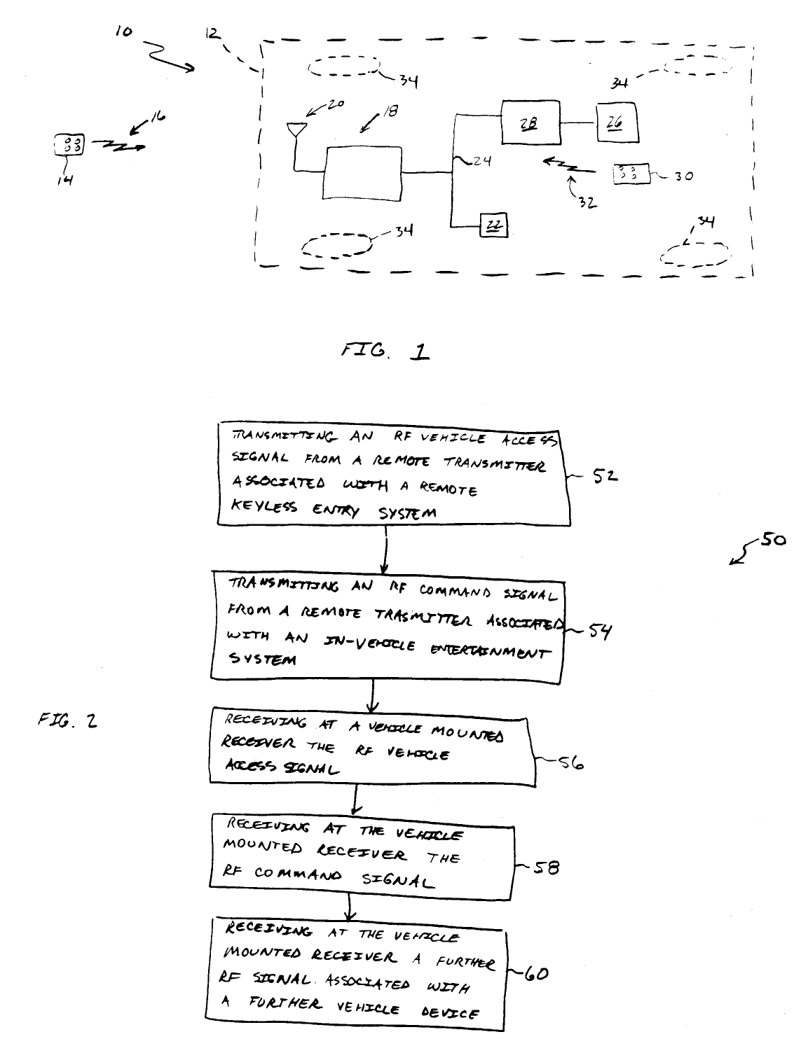

Referring now to FIG. 1, a simplified, representative block diagram of an embodiment of the system of the present invention is shown, denoted generally by reference numeral 10. As seen therein, the system (10) is designed for use in a vehicle (12) equipped with a remote keyless entry (RKE) system and an in-vehicle entertainment system.

In that regard, the RKE system includes a remote transmitter or “fob” (14). RKE fob (14) is for use in transmitting a radio frequency (RF) vehicle access signal (16). A receiver (18) mounted on-board vehicle (12) includes an antenna (20) and is configured and provided for receiving vehicle access signal (16) transmitted by RKE fob (14). Receiver (18) is provided in communication with a vehicle access device, such as a door lock mechanism (22). Receiver (18) and door lock mechanism (22) are preferably provided in communication using a vehicle bus (24), although receiver (18) and door lock mechanism (22) may alternatively be provided in direct communication.

Receiver (18) receives vehicle access signals (16) transmitted by RKE fob (14) for use in controlling door lock mechanism (22) to perform a vehicle access function, such as locking or unlocking a vehicle door (not shown). As noted above, receiver (18) may also be provided in communication with other vehicle access devices for performing other vehicle access functions, such as opening a vehicle trunk (not shown), in any fashion known in the art.

In that regard, RKE fob (14) may be provided for use in either an active or passive RKE system. If provided for use in an active system, RKE fob (14) transmits vehicle access signals (16) in response to operation or activation of buttons or switches on RKE fob (14) by a user (not shown). As previously noted, such vehicle access signals (16) are for use in controlling door lock mechanism (22) to lock or unlock a vehicle door (not shown) in a fashion well known in the art.

If provided for use in a passive system, RKE fob (14) is designed in a fashion well known in the art to automatically transmit vehicle access signals (16) for use in controlling door lock mechanism (22) to unlock a vehicle door (not shown) as a user carrying RKE fob (14) approaches vehicle (12), without the need for operation by a user of any switch or button on RKE fob (14). Similarly, in a fashion well known in the art, RKE fob (14) is designed to automatically transmit vehicle access signals (16) for use in controlling door lock mechanism (22) to lock a vehicle door (not shown) as the user, carrying RKE fob (14), moves away from vehicle (12).

In either a passive or active system, vehicle access signals (16) are received by vehicle mounted receiver (18). As described above, receiver (18) is provided in communication with door lock mechanism (22). In that regard, it should be noted that receiver (18) may include a controller, or may be provided in communication with a controller (not shown) which is in turn provided in communication with door lock mechanism (22), for controlling operation of door lock mechanism (22) in response to receipt by receiver (18) of vehicle access signals (16).

In the exemplary embodiment shown in FIG. 1, the in-vehicle entertainment system includes a monitor (26) and a digital video disk (DVD) player (28) provided in communication with each other. It should be noted, however, that the in-vehicle entertainment system may include various additional and/or alternative equipment (not shown) known in the art, such as a video cassette recorder (VCR), a compact disk (CD) player, a radio, a sound system, or other devices or systems.

The in-vehicle entertainment system further includes remote control device or unit (30), which is preferably hand-held. Remote control (30) is for use by a vehicle occupant (not shown) to transmit radio frequency (RF) command or control signals (32) for use in controlling various functions associated with DVD player (28), monitor (26), or other equipment (not shown) associated with the in-vehicle entertainment system. For example, such RF command signals (32) may be for use in activating or deactivating the in-vehicle entertainment system, playing a DVD, CD or VCR tape, selecting a radio station or tuning a radio to a station, controlling the volume of an associated sound system, or any of a number of other well known functions of an in-vehicle entertainment system.

In that regard, according to the system (10) of the present invention, receiver (18) is also configured and provided for receiving such RF command signals (32) transmitted by remote control (30). As seen in FIG. 1, receiver (18) is provided in communication with DVD player (28), monitor (26) and/or any other equipment (not shown) that may be associated with the in-vehicle entertainment system. Here again, receiver (18), DVD player (28) and/or monitor (26) are preferably provided in communication using vehicle bus (24), although such devices may alternatively be provided in communication directly. As a result, DVD player (28), monitor (26) and/or any other equipment (not shown) that may be associated with in-vehicle entertainment system perform the intended function represented by or associated with the RF command signal (32) transmitted by remote control (30).

As is readily apparent, then, receiver (18) acts to receive RF vehicle access signals (16) transmitted by RKE fob (14) and associated with the vehicle remote keyless entry system, as well as RF command signals (32) transmitted by remote control (30) and associated with the in-vehicle entertainment system. Shared in such a fashion, receiver (18) thereby provides for significant cost advantages over a receiver dedicated for use in the in-vehicle entertainment system.

In a similar fashion, receiver (18) may be used for receiving other RF signals associated with other vehicle devices. For example, receiver (18) may also be configured to receive RF tire pressure signals (not shown) that may be transmitted from tire pressure monitors (not shown) mounted in vehicle tires (34). Once again, in such a fashion, shared receiver (18) provides cost advantages over receivers dedicated to such other vehicle devices or systems.

Referring next to FIG. 2, a simplified, representative flowchart of an embodiment of the method of the present invention is shown, denoted generally by reference numeral 50. The method (50) is provided for use in a vehicle having a remote keyless entry system and an in-vehicle entertainment system as described above. The method (50) is for controlling the in-vehicle entertainment system and comprises transmitting (52) a radio frequency vehicle access signal from a remote transmitter associated with the remote keyless entry system, and transmitting (54) a radio frequency entertainment system command signal from a remote transmitter associated with the in-vehicle entertainment system. The method (50) further comprises receiving (56) at a vehicle mounted receiver the radio frequency vehicle access signal, and receiving (58) at the vehicle mounted receiver the radio frequency command signal.

In that regard, as described above, the vehicle mounted receiver is provided in communication with the in-vehicle communication system and with a vehicle access device associated with the remote keyless entry system. The method (50) may further comprise receiving (60) at the vehicle mounted receiver a further radio frequency signal associated with a further vehicle device, as also described above.

It should be noted that the simplified flowchart depicted in FIG. 2 is exemplary of the method (50) of the present invention. In that regard, the method (50) may be executed in sequences other than those shown in FIG. 2, including the execution of a subset of the steps and/or functions shown, and/or the execution of one or more of such steps and/or functions simultaneously.

From the foregoing description, it can be seen that the present invention provides, in a vehicle having a remote keyless entry system and an in-vehicle entertainment system, a system and method for controlling the in-vehicle entertainment system that utilizes a shared receiver. The system and method of the present invention preferably include a single receiver for receiving both RF vehicle access signals associated with the remote keyless entry system, and RF command signals associated with the in-vehicle entertainment system.

According to the present invention, the shared receiver is preferably provided in communication with a vehicle access device and the in-vehicle entertainment system using a vehicle bus, thereby allowing the vehicle access device and entertainment system to perform the intended function associated with the received vehicle access and entertainment command signals. In such a fashion, the present invention provides cost advantages over devices or systems utilizing dedicated receivers.

While various embodiments of the invention have been illustrated and described, it is not intended that these embodiments illustrate and describe all possible forms of the present invention. Rather, the words used in the specification are words of description rather than limitation, and it is understood that various changes may be made without departing from the spirit and scope of the invention. Indeed, many alternatives, modifications, and variations will be apparent to those skilled in the art in light of the foregoing description, and the present invention is intended to embrace all such alternatives.

What is claimed is:

1. In a vehicle having a remote keyless entry system and an in-vehicle entertainment system, a system for controlling the in-vehicle entertainment system comprising:
a remote transmitter for transmitting a radio frequency vehicle access signal for use in controlling a vehicle access function; and
a receiver to be mounted on-board the vehicle for receiving the vehicle access signal, the receiver to be provided in communication with a vehicle access device for performing the vehicle access function, the receiver further to be provided in communication with the in-vehicle entertainment system and for receiving a radio frequency command signal for use in controlling the in-vehicle entertainment system.

2. The system of claim 1 further comprising a remote transmitter for transmitting the radio frequency command signal.

3. The system of claim 1 wherein the receiver is provided in communication with the in-vehicle entertainment system and the vehicle access device using a vehicle bus.

4. The system of claim 2 wherein the in-vehicle entertainment system comprises a compact disk player, and the radio frequency command signal comprises a signal for use in playing a compact disk.

5. The system of claim 2 wherein the in-vehicle entertainment system comprises a monitor and a video cassette recorder, and the radio frequency command signal comprises a signal for use in playing a video cassette.

6. The system of claim 2 wherein the in-vehicle entertainment system comprises a monitor and a digital video disk player, and the radio frequency command signal comprises a signal for use in playing a digital video disk.

7. The system of claim 4 wherein the vehicle access device comprises a vehicle door lock mechanism and the vehicle access function is a door unlock function.

8. The system of claim 1 wherein the receiver is for receiving a further radio frequency signal associated with a further vehicle device.

9. The system of claim 8 wherein the further vehicle device comprises a tire pressure monitor and the further radio frequency signal comprises a tire pressure signal.

10. In a vehicle having a remote keyless entry system and an in-vehicle entertainment system, a system for controlling the in-vehicle entertainment system comprising:
a remote transmitter for transmitting a radio frequency command signal for use in controlling the in-vehicle entertainment system; and
a receiver to be mounted on-board the vehicle, the receiver to be provided in communication with the in-vehicle entertainment system and for receiving the command signal, the receiver further to be provided in communication with a vehicle access device and for receiving a radio frequency vehicle access signal for use in controlling the vehicle access device.

11. The system of claim 10 further comprising a remote transmitter for transmitting the radio frequency vehicle access signal.

12. The system of claim 10 wherein the receiver is provided in communication with the in-vehicle entertainment system and the vehicle access device using a vehicle bus.

13. The system of claim 12 wherein the in-vehicle entertainment system comprises a compact disk player, and the radio frequency command signal comprises a signal for use in playing a compact disk.

14. The system of claim 10 wherein the in-vehicle entertainment system comprises a monitor and a video cassette recorder, and the radio frequency command signal comprises a signal for use in playing a video cassette.

15. The system of claim 10 wherein the in-vehicle entertainment system comprises a monitor and a digital video disk player, and the radio frequency command signal comprises a signal for use in playing a digital video disk.

16. The system of claim 13 wherein the vehicle access device comprises a vehicle door lock mechanism and the vehicle access signal is for use in controlling the vehicle door lock mechanism to perform a door unlock function.

17. The system of claim 10 wherein the receiver is for receiving a further radio frequency signal associated with a further vehicle device.

18. The system of claim 17 wherein the further vehicle device comprises a tire pressure monitor and the further radio frequency signal comprises a tire pressure signal.

19. In a vehicle having a remote keyless entry system and an in-vehicle entertainment system, a method for controlling the in-vehicle entertainment system comprising:
transmitting a radio frequency vehicle access signal from a remote transmitter associated with the remote keyless entry system;
transmitting a radio frequency entertainment system command signal from a remote transmitter associated with the in-vehicle entertainment system;
receiving at a vehicle mounted receiver the radio frequency vehicle access signal; and
receiving at the vehicle mounted receiver the radio frequency command signal, wherein the vehicle mounted receiver is provided in communication with the in-vehicle communication system and with a vehicle access device associated with the remote keyless entry system.

20. The method of claim 19 further comprising receiving at the vehicle mounted receiver a further radio frequency signal associated with a further vehicle device.
